(19) United States
(12) Patent Application Publication
(10) Pub. No.: US 2009/0061862 A1
(43) Pub. Date: Mar. 5, 2009

(54) PEER TO PEER SERVICE DISCOVERY SHARING

(76) Inventors: William P. Alberth, JR., Prairie Grove, IL (US); Armin W. Klomsdorf, Libertyville, IL (US); Michael D. Kotzin, Buffalo Grove, IL (US); Eric L. Krenz, Crystal Lake, IL (US); James E. Mitzlaff, Arlington Heights, IL (US); James P. Phillips, Lake in the Hills, IL (US); Lorenzo A. Ponce De Leon, Lake Worth, FL (US); Charles B. Swope, Coral Springs, FL (US)

Correspondence Address: MOTOROLA INC, 600 NORTH US HIGHWAY 45, W4 - 39Q, LIBERTYVILLE, IL, 60048-5343, US

(21) Appl. No.: 11/848,212

(22) Filed: Aug. 30, 2007

(51) Int. Cl. H04Q 7/20

(52) U.S. Cl. 455/434

(57) ABSTRACT

If the mobile station (101) locates a peer it will request network metadata and may obtain location related services or service lists. The mobile station (101) negotiates with one of more peers (103) to share the work load of background scanning for network services. After successful negotiation, any peers in the “discovery net” will report or advertise to each other of any newly discovered networks, or networks to which connectivity has been lost. Since the various mobile stations may, when powered on, scan periodically for network changes, the metadata stored on the mobile station (101) will be dynamic and will change periodically upon travels and/or encounters with additional peers. Because the peers (103) may also possess location information, the mobile station (101) may additionally adjust its scan to prioritize services advertised by those members of peers (103) that are located most proximate to the mobile station (101).

### FIELD OF THE DISCLOSURE

The present disclosure is related to peer-to-peer service discovery by mobile communications devices employing various wireless technologies.

### BACKGROUND

Mobile communication devices, which are commonly referred to as “mobile stations,” may employ any number of radio interfaces such as various cellular interfaces, WLAN, etc. Cellular networks normally provide a mobile station with a “neighbor list” of cells such that the mobile station may handover between neighbor cells if necessary. A network may also provide a mobile station with information about available alternative networks. For example, a cellular network may provide a mobile station with information about neighboring networks or WLAN channels that are in the vicinity of the mobile station.

As the number of available wireless networks increases, so too does the burden on a mobile station, particularly a mobile station in the “waking” state, to scan for, and identify suitable networks with which to establish a connection. When a mobile station is initially powered on and thus “waking,” it may need to scan for some period of time before retrieving all network availability information, which places a burden on the mobile station battery.

Additionally, many mobile stations have the capability to access content from the Internet, for example, maps, directories, etc. Although content access may be provided by the various networks, such content access may be limited by network bandwidth and/or channel availability, etc., at any particular time. The process of a mobile station discovering available services and/or available content is usually referred to as “service discovery” or “discovery.”

The Internet provides mechanisms for quickly identifying sources of content. For example various music services, if logged onto by a World Wide Web (WWW) user, may inform the user of other servers from which the user may download information, for example, specific songs or songs from a specific artist.

It would be beneficial if a mobile station could, upon entering the waking state, have a service discovery process that is faster and more efficient than current systems, so as to conserve battery power and improve a user's experience.

Therefore, a need exists for a faster mobile station service discovery method and apparatus.

### BRIEF DESCRIPTION OF THE DRAWINGS

FIG. 1 is a diagram of a peer-to-peer network wherein mobile stations may share discovery information in accordance with the embodiments.

FIG. 2 is flow chart illustrating operation of a mobile station in accordance with the embodiments.

FIG. 3 is a flow chart illustrating operation of a mobile station in accordance with an embodiment.

### DETAILED DESCRIPTION

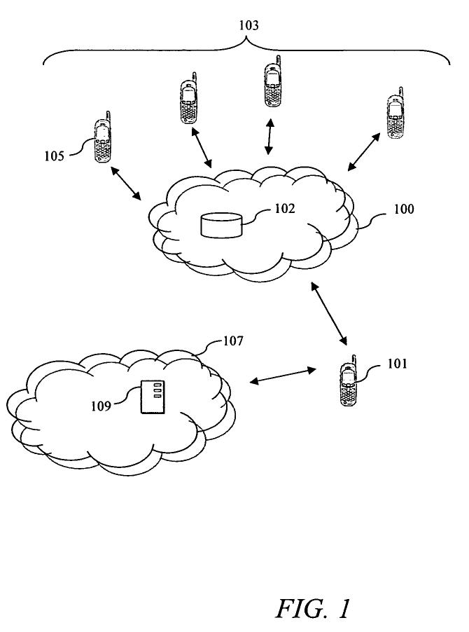

FIG. 1 illustrates a peer-to-peer network of the embodiments in which a mobile station 101 may obtain discovery information from one or more peers from a group of peers 103. The mobile station 101, upon being powered on will enter a waking state and will begin an initial preliminary scan for known networks using the mobile station 101 wireless capabilities, for example, cellular, Wimax™, WLAN, Bluetooth™, or RFID™, or any other technology at the disposal of the mobile station 101. Such known networks include networks to which the mobile station 101 may have had a connection with prior to being powered down, and networks that the mobile station 101 may have stored in memory after having completed previous scans. For example the mobile station 101 may store a list of known networks including network capabilities such as, but not limited to, throughput, latency, and cost of data. The mobile station 101 will use capability criteria from the list to determine whether a particular network is suitable for an intended usage. For example if a large file is to be transmitted by the mobile station 101 then a WLAN network would be preferred to a 2G cellular network, provided that any other necessary criteria are met, based upon the larger data throughput capability of the WLAN. The WLAN may therefore in such cases be selected as the desired network for establishing a connection.

For example, the mobile station 101 may have been connected to network 107 prior to powering down and thus may immediately begin to search for network 107 upon waking due to network 107 metadata stored in the mobile station 101 memory. Such network metadata may include type of network (such as CDMA, WiMAX™, GSM, 802.11a, etc.), a carrier or operator identifier, network parameters such as System Identifiers (SID) and Network Identifier (NID), available channels or frequencies, signal strength, Quality of Service (QoS), active set, neighbor list, and overhead information being transmitted by the network, present network loading, data timestamps, or any other information the peer may be able to share with another peer, etc. The mobile station 101 may also store a list of known systems which is also included in the term “metadata” as used herein.

The mobile station 101 will attempt to obtain information related to its velocity and direction, which may be obtained by a location server 109 via the known network 107. The location server 109 may have access to Global Positioning System (GPS) information and may receive some GPS coordinate information from the mobile station 101 if the mobile station 101 has a GPS capability. Various techniques exist for determining a mobile station location as would be understood by one of ordinary skill, and thus any such techniques are appropriately applicable for the embodiments herein disclosed.

Thus the mobile station 101 obtains its location, and/or velocity and direction in cases where the mobile station 101 is traveling such as when it is in a car, train, etc. For the cases in which the mobile station 101 is in motion, its velocity information will be averaged over some period of time such that periodic stops, such as stops at traffic lights or stops at train stations, do not change a general indicator that the mobile station 101 is in motion. In any case, the mobile station 101 may make a determination that it is in motion, or that it is relatively still.

The mobile station 101 can also obtain motion information or an improved location, and/or velocity and direction in cases where the mobile station 101 is in motion through use of embedded sensors. In this case, the use of an 3D accelerometer and/or 3D Gyroscope can be used to extend a last known location or to determine motion dynamics of the mobile station itself. Additional sensors, such as a light, temperature, or pressure sensor can also be used to determine a context based location or motion dynamics used in mobile station discovery or proximity to other mobile stations.

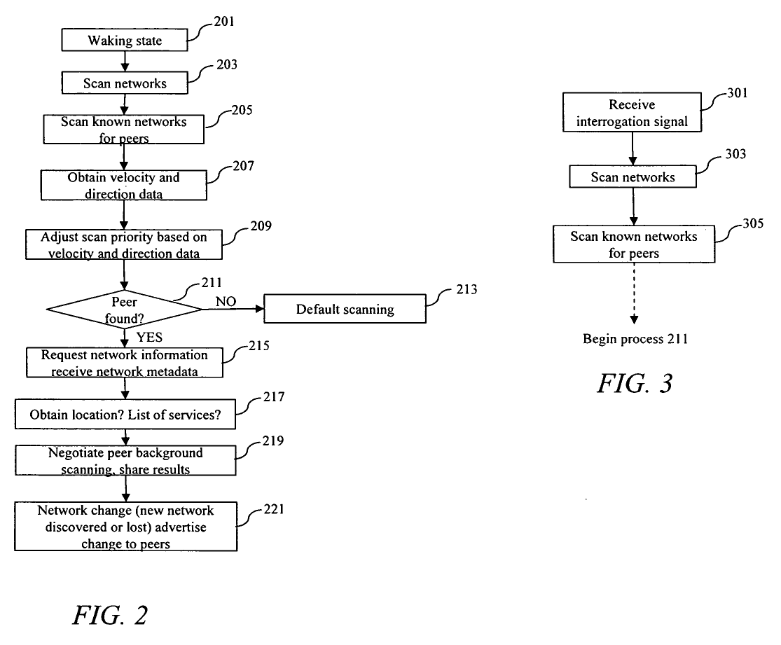

Mobile station 101 also comprises a peer-to-peer client for communication with peers via any of the various wireless capabilities. FIG. 2 is a flow chart illustrating operation of the mobile station 101 of the present embodiments and will thus be referred to henceforth in addition to FIG. 1. As was discussed above, the mobile station 101 will, upon power up, enter a waking state 201 and begin a preliminary network scan 203. The mobile station 101 will also begin to scan for peers 205 for example, the peers 103 via an available peer-to-peer infrastructure such as the network 100. The scanning for peers may occur prior to, or in parallel with, the velocity determination 207 as was discussed above. The velocity information obtained in 207 will also include direction data in the event the mobile station 101 is in motion. The mobile station 101, after obtaining the mobile station 101 velocity data, will adjust its scan with respect to the types of networks scanned for, to limit the scan to networks that can be expected to support the mobile station 101 speed and direction of travel. For example, the mobile station 101 will not expend power scanning for a WLAN in a coffee shop that it is moving rapidly away from, or could not connect to because of its velocity.

If the mobile station 101 locates a peer in 211, for example peer 105 via peer-to-peer network 100, the mobile station 101 will request network metadata as in 215 and may obtain location related services or service lists in 217. If no peers are found in 211 the mobile station 101 will perform a default scan 213 as would be the case without the present embodiments.

The mobile station 105 may provide information to mobile station 101 such as a service database 102 of the local network, for example network 100, which the mobile station 101 may then access via the peer-to-peer, or possibly via another network such as cellular.

The mobile station 101 will then negotiate with the peer 105, or with any one of more of several peers 103, to share the work load of background scanning for network services as in 219. After successful negotiation, any peers in the “discovery net” will report or advertise to each other of any newly discovered networks, or networks to which connectivity has been lost. Since the various mobile stations may, when powered on, scan periodically for network changes, the metadata stored on the mobile station 101 for various networks will be dynamic and will change periodically as the mobile station 101 travels and/or encounters additional peers.

Because the peers 103 may also possess location information, the mobile station 101 may additionally adjust its scan to prioritize services advertised by those members of peers 103 that are located most proximate to where mobile station 101's velocity vector indicates mobile station 101 will be in future time.

In addition to initiating a preliminary network scan 203 or a scan for peers 205 upon power up, the mobile station may initiate a scan upon receiving an interrogation signal from a short range communication network or device. For example, the interrogation signal may be sent from a WLAN access point, a Bluetooth™ access point, an RFID™ tag reader or other transponder interrogator or any other suitable short range network technology or device. This interrogation signal may, for example, be used to control access to a controlled area such as a building or other geographic area. The mobile station may. in some embodiments, reply to this interrogation signal in order to allow the user to gain entry into the controlled area. Since it is likely that there will be different, or additional. communication network or networks serving the controlled area, such as a building, the mobile station should perform a new scan to discover the appropriate networks to use in this new environment. Thus in FIG. 3, the mobile station receives an interrogation signal in 301. In 303 the mobile station will begin a scan for networks such as WLAN or other short range networks related to the mobile station's current location. In 305 the mobile station may search for peers to more quickly obtain metadata for any present networks. Additionally in some embodiments, the mobile station may proceed with the steps beginning at block 211 in FIG. 2, to receive network metadata in a case where one or more peers is located.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station, said mobile station comprising at least two radio interfaces and a peer-to-peer client, said method comprising:
performing a network scan, wherein said scan is limited by at least one parameter; and
sharing a result of said network scan with said at least one peer.

2. The method of claim 1, further comprising:
negotiating with at least one peer for dividing a network scanning workload.

3. The method of claim 2, further comprising:
receiving from said at least one peer, metadata obtained from a scan portion performed by said at least one peer, in response to said negotiating, said scan portion representing a portion of said network scanning workload.

4. The method of claim 1, further comprising:
powering on the mobile station and entering into a wake state; and
performing a preliminary scan for available networks.

5 The method of claim 4, further comprising:
scanning for a group of peers on at least one of said available networks.

6. The method of claim 5, further comprising:
obtaining velocity and direction data associated with the position and velocity of said mobile station, and setting said at least one parameter based upon said velocity and direction data.

7. A method of operating a peer-to-peer system, said peer-to-peer system including at least a first mobile station and a second mobile station, each mobile station comprising at least two radio interfaces and a peer-to-peer client, said method comprising:
sharing, by said first mobile station, service information obtained from a first radio interface, with said second mobile station, said service information communicated to said second mobile station using said second radio interface.

8. The method of claim 7, further comprising:
performing a network scan by said first mobile station and communicating results of said network scan with said second mobile station.

9. The method of claim 8, wherein said first mobile station maintains a list of networks to be periodically monitored for availability by said first mobile station, the method further comprising:
negotiating with said second mobile station by said first mobile station, at least one network from said list of networks, for second device to monitor for availability;
monitoring of said at least one network for availability by said second mobile station; and
reporting to said first mobile station by said second mobile station a result of said monitoring for availability.

10. The method of claim 7, wherein said second radio interface is a Wireless Local Area Network radio interface.

11. The method of claim 7, further comprising:
powering on said first mobile station and entering into a wake state; and
performing a preliminary scan for available networks by said first mobile station.

12. The method of claim 7, further comprising:
scanning for a group of peers using at least one of said at least two radio interfaces.

13. The method of claim 11, further comprising:
determining by said first mobile station a velocity of said first mobile station; and
limiting said preliminary scan to networks that can accommodate said velocity.

14 The method of claim 11, further comprising:
determining by said first mobile station a direction of said first mobile station; and
prioritizing said preliminary scan to services advertised by peers located in said direction.

15. The method of claim 7, further comprising:
receiving by said second mobile station an interrogation signal, said interrogation signal being triggered by said second mobile station being near a geographic boundary; and
sending a message from said second mobile station to said first mobile station, in respond to said interrogation signal, said message notifying said first mobile station to perform a network scan.

16. The method of claim 15, wherein said geographic boundary is an entry point to a building.

17. A method of operating a peer-to-peer system, said peer-to-peer system including at least a first mobile station and a group of peer mobile stations, each mobile station comprising at least two radio interfaces and a peer-to-peer client, said method comprising:
determining by said first mobile station that said group of peer mobile stations is within a proximity of said first mobile station; and
requesting, by said first mobile station from said group of peer mobile stations, network availability information.

18. The method of claim 17, further comprising:
requesting, by said first mobile station from said group of peer mobile stations, service information obtained from a first radio interface, by said group of peer mobile stations; and
communicating said service information to said first mobile station by said group of peer mobile stations using said second radio interface.
